(19) United States
(12) Patent Application Publication
(10) Pub. No.: US 2023/0214738 A1
(43) Pub. Date: Jul. 6, 2023

(54) MATCHING INDIVIDUALS AND ENTITIES BASED ON DETERMINED QUALIFICATION CHARACTERSITICS

(71) Applicant: Erik Stanley Schwartz, West Palm Beach, FL (US)

(72) Inventor: Erik Stanley Schwartz, West Palm Beach, FL (US)

(21) Appl. No.: 18/151,272

(22) Filed: Jan. 6, 2023

Related U.S. Application Data
(60) Provisional application No. 63/296,968, filed on Jan. 6, 2022.

(51) Int. Cl. G06Q 10/0631; G06Q 10/1053; G06F 40/40

(52) U.S. Cl. CPC G06Q 10/063112; G06Q 10/1053; G06F 40/40

(57) ABSTRACT

The application describes matching individuals with entities. More specifically, the present application describes a process whereby an entity may find qualified individuals for various employment positions offered by the entity. Likewise, examples of the present application enable an individual to specify skills, experience and/or qualifications offered by the individual and subsequently provide this information to various entities.

### CROSS-REFERENCE TO RELATED APPLICATION

The present application claims priority to U.S. Provisional Patent Application No. 63/296,968 filed on Jan. 6, 2022 and titled “Matching Individuals and Entities Based on Determined Qualification Characteristics”, the entire disclosure of which is hereby incorporated by reference in its entirety.

### BACKGROUND

It can be difficult to find individuals to fill various employment positions across a wide range of industries. For example, it may be difficult for an organization or other entity to find and hire an individual with a requisite skill set and/or experience to fill a particular role within the organization.

### SUMMARY

The present application relates to matching individuals with entities. More specifically, the present application describes a process whereby an entity may find qualified individuals for various employment positions offered by the entity. Likewise, examples of the present application enable an individual to specify skills, experience and/or qualifications offered by the individual and subsequently provide this information to the various entities.

Accordingly, the present application describes a method for matching individuals having a particular skill set with various entities. This method may include receiving one or more qualification requirements associated with an entity and receiving experience information associated with an individual. The qualification requirements are normalized based, at least in part, on a first criterion. Likewise, the experience information is normalized based, at least in part, on a second criterion. A mapping between the normalized qualification requirements and the normalized experience information is generated. A user interface is generated based, at least in part, on the mapping between the normalized qualification requirements and the normalized experience information. The user interface may be provided to a computing device associated with the individual and/or the entity.

Also described is a system that includes at least one processor and a memory. The memory stores instructions that, when executed by the at least one processor, perform operations. In an example, the operations include receiving one or more qualification requirements associated with an entity and receiving experience information associated with an individual. The qualification requirements are normalized based, at least in part, on a first criterion. The experience information is normalized based, at least in part, on a second criterion. A mapping between the normalized qualification requirements and the normalized experience information is used to generate a user interface. The user interface may then be provided to a computing device.

The present application also describes a method that includes receiving experience information associated with an individual, normalizing the experience information based, at least in part, on a criterion, comparing the normalized experience information to received qualification requirements associated with an entity, the qualification requirements being associated with a hierarchy, generating a user interface based, at least in part, on the comparing and providing the user interface to a computing device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an example system for matching individuals with particular skill sets to various entities according to an example.

FIG. 1B illustrates the example system of FIG. 1A in which a notification is provided to a first computing device associated with the entity and a second computing device associated with the individual according to an example.

FIG. 2 illustrates a method for matching and individual with a particular skill set with one or more entities according to an example.

FIG. 3A illustrates an example user interface that shows a list of all available candidates that meet criteria for a particular entity according to an example.

FIG. 3B illustrates the user interface of FIG. 3A after a filter has been applied to the information displayed in the user interface according to an example.

FIG. 4A illustrates another example user interface according to an example.

FIG. 4B illustrates the user interface of FIG. 4A after a filter has been applied to the information displayed in the user interface according to an example.

FIG. 5 is a block diagram of a computing device according to one or more examples.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As indicated above, it can be difficult to find individuals to fill various positions across a wide range of industries. For example, it may be difficult for a company or other organization (referred to herein as an “entity”) to find and hire individuals having requisite skill sets and/or experience to fill a particular role. Additionally, it may be difficult for an individual to find a position with a particular entity that the individual is passionate about and/or that is a good fit for the individual based on his or her skill set.

Accordingly, the present application describes a system that receives information about one or more employment positions associated with an entity. In some examples, the information may be received in real-time or substantially real-time. For example, the information may be received via an electronic communication such as, for example, an email, text message, fillable form, electronic document or other electronic message. In another example, the information may be received via a natural language conversation such as, for example a phone conversation, a face-to-face conversation between two individuals, a virtual meeting and so on. In some examples, as the conversation is occurring, the system described herein transcribes the conversation or otherwise changes the format of the information so as to be understandable by the system.

As the information is received, the information may be normalized according to various criteria. For examples, the system may recognize or learn to recognize certain key words or phrases. In an example, the key words or phrases may be associated with a heat map or other scoring mechanism that may be used to categorize responses.

The normalization may help ensure that any information received from a variety of different entities is standard. For example, different entities may be looking for individuals with the same or similar qualifications but during the information gathering process, each entity may represent its needs in different ways. The normalization may be used to help ensure that the system is clearly representing the qualifications the entity is requesting.

In another example, the system described herein may use the gathered information from the entity to automatically generate a questionnaire or other document that is specific to the entity. For example, as the information is received by the system, the system may analyze the information to identify and/or generate one or more questions that may subsequently be provided to various candidates (e.g., during a recruiting interview). In some examples, as the system generates the questions for the questionnaire, the system may consider additional information and revise the questionnaire in real-time or substantially real-time. The additional information may include demographic information about potential candidates, geographical disbursement of potential candidates, geographical disbursement of similar opportunities, compensation, interests of the individual, and so on.

As indicated above, the system may update the questionnaire in real-time or substantially real-time. For example, as the system receives answers to the questions from various candidates, the system may use the answers to revise a wording of a question, may add additional questions, may remove questions, or may update or otherwise edit the job description and/or the job requirements. In another example, the system may update the questionnaire based on additional information received from the entity.

The system described herein also gathers experience information from one or more individuals. In some examples, the experience information may be received in real-time or substantially real-time. For example, the experience information may be received via an electronic communication and/or a natural language conversation. The system described herein may transcribe the conversation or otherwise change the format of the information associated with the conversation such that the information is understandable by the system.

As the experience information is received, the experience information may be normalized according to various criteria. For example, during a conversation (e.g., spoken or written) between individuals, the system may detect or otherwise recognize various key words. In one example, key words may be associated with a score or other indicator that represents needs or wants the entity (or the individual or candidate) is looking for. As such, points of the conversation that are most relevant to a particular entity or individual may be easily identified.

The criteria may be the same criteria or different criteria than that used to normalize the qualification information. The normalization may help ensure that information received from various individuals is standard. This may help ensure that the system is clearly representing the experience and/or qualifications the individual is offering.

In an example, the experience information may be provided to the system in response to the individual answering one or more questions in a generated questionnaire such as described above. The experience information may also include an individual's experience or knowledge of the entity that is associated with the questionnaire. For example, when answering questions in the questionnaire, the individual may provide information about the individual's perception of the entity, a market response associated with the entity, brand strength associated with the entity and so on. As indicated above, all of the gathered information may be used to update or otherwise revise the questions in the questionnaire, the description/requirements of the opportunity, and/or a salary associated with the opportunity.

When the information from the various individuals and/or the various entities is received, the system described herein may perform a matching process using the standardized information. For example, the system may generate one or more matrices that include information about the requested qualifications and how the experience of one or more individuals matches the requested qualifications. Although a matrix is specifically mentioned, the information may take any suitable form. In some examples, the system may generate an output that includes the matching information. The information may be provided to the individual and/or the entity.

In some examples, the system may receive additional information from the individual and/or the entity. The additional information may include information as to why the individual did or did not accept a position offered by the entity. In another example, the additional information may include information as to why the entity did not offer the individual an employment position. In another example, the additional information may include information about the interests of the individual and/or the entity. For example, the additional information may include information corresponding to diversity, equity and inclusion efforts by the entity and/or the individual, opportunities and/or interest for advancement, contacts of the individual that work with or are otherwise associated with the entity and so on. The additional information may be received and subsequently presented to the entity and/or the individual in the same manner as described above.

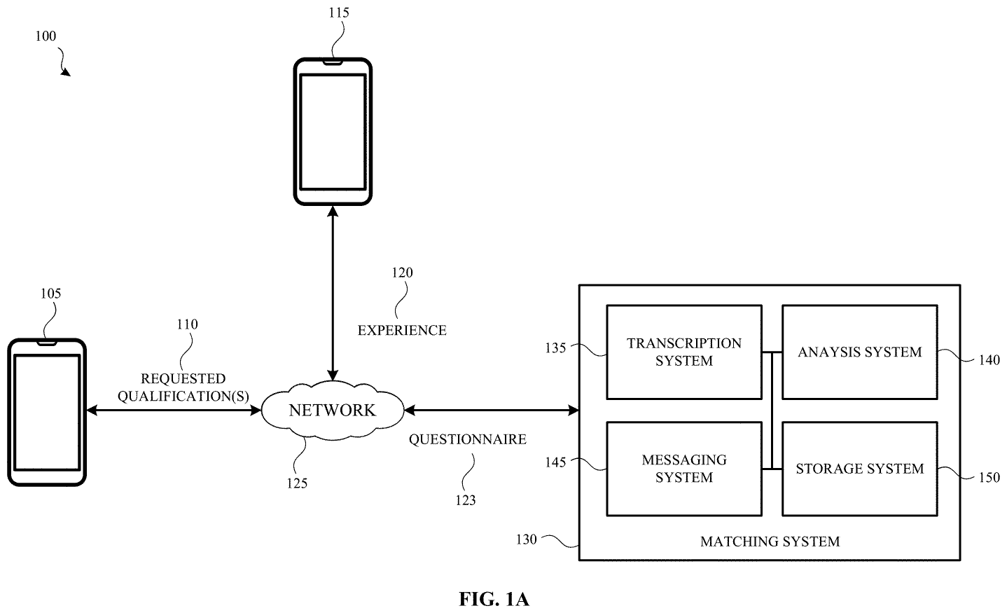

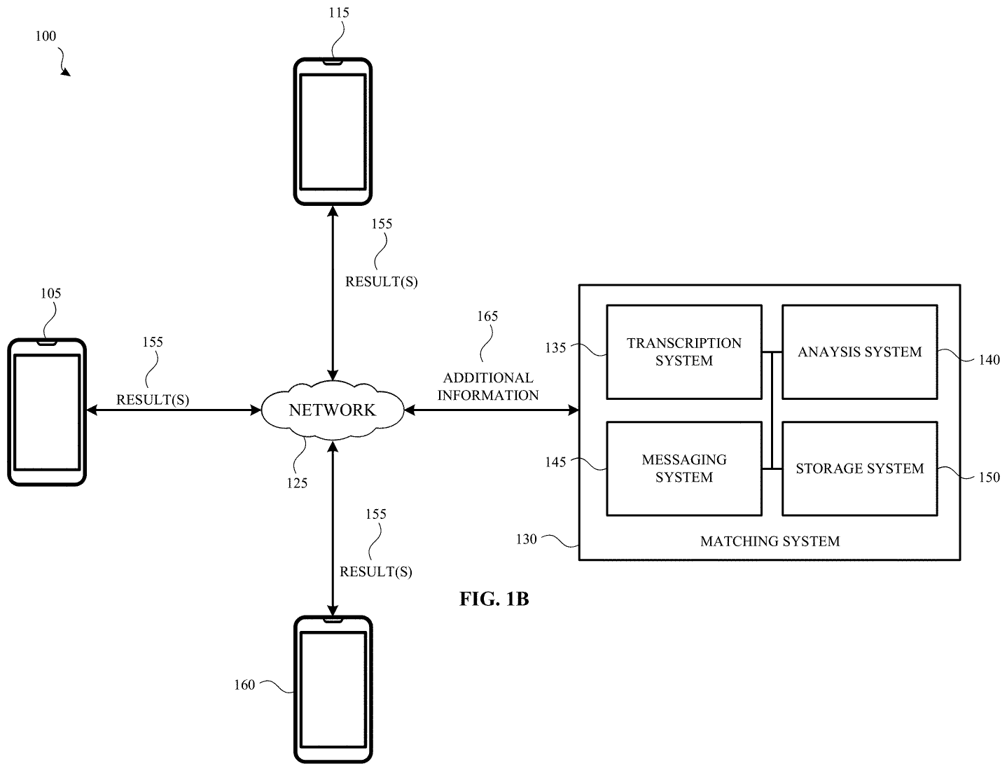

These and other examples will be shown and described in greater detail with respect to FIG. 1A-FIG. 5.

FIG. 1A illustrates an example system 100 for matching individuals having particular skill sets to various entities according to an example. The system 100 may include a number of computing devices and each computing device may be associated with an entity or an individual. For example, computing device 105 may be associated with an entity while computing device 115 may be associated with an individual. Although two computing devices are shown and described, the system 100 may include any number of computing devices that are each associated with a number of different entities and/or individuals.

As shown in FIG. 1A, the first computing device 105 may communicate with a matching system 130 via a network 125. Likewise, the second computing device 115 may communicate with the matching system 130 via the network 125. In an example, an entity associated with the first computing device 105 may have an employment opportunity for one or more individuals. The employment opportunity may require a particular skill set. As such, the first computing device 105 may provide requested qualifications 110 to the matching system 130 via the network 125.

The requested qualifications 110 may be provided to the matching system 130 in a number of ways. For example, an individual (e.g., a recruiter) associated with a provider of the system 100 may have a conversation with an individual associated with entity. During the conversation, the individual associated with the provider of the system may ask for information about the opportunity such as, for example, technical skills required for the opportunity, advancement opportunities, benefits, salary range, location information and so on.

The conversation may also enable the matching system 130 to receive general information about the entity. The general information may include information about the global and/or national footprint of the entity, initiatives and/or special interest groups the entity is involved with, recruiting policies/focus, and so on.

As this information is received by the matching system 130, the information is provided to a transcription system 135. In some examples, the information is provided to transcription system 135 in real-time or substantially real-time. In another example, the information may be provided to the transcription system 135 upon completion of the conversation. In some examples, the requested qualifications 110 may be included in an electronic message or other form of electronic communication. For example, an individual associated with the entity may access the first computing device 105 and provide the requested qualifications 110 to the transcription system 135 via an email, internet fillable form, word processing document and so on.

Upon receipt of the requested qualifications 110, the transcription system 135 may analyze or otherwise process the requested qualifications 110. In an example, the processing may include standardizing the information based on one or more criteria. In another example, the processing may be used to format the requested qualifications 110 such that an analysis system 140 of the matching system 130 may be able to understand the information associated with the requested qualifications 110.

In some examples, the information associated with the requested qualification 110 information may be provided from the transcription system 135 to the analysis system 140 of the matching system 130. The analysis system 140 may check and edit the transcription. The analysis system 140 may also analyze the information and generate, in real-time or substantially real-time, a questionnaire 123 or other document that is associated with the information contained in the requested qualifications 110. The questionnaire 123 that is generated is specific to the entity that provided the requested qualification 110 information. In an example, the analysis system may be or otherwise include an artificial intelligence system that learns how and when to create and/or edit the questionnaire. In an example, this may be in response to feedback. In another example, the learning may occur based on one or more received answers to particular questions that are provided. For example, if multiple follow-up questions are generated in order to obtain a desired answer, the analysis system 140 may learn how to better generate questions that require fewer follow-up questions.

The questionnaire 123 includes questions that are to be asked to one or more individuals that are interested in the opportunity offered by the entity. The questionnaire 123 may include questions that are specific to the opportunity (e.g., whether the individual has experience in a particular field) and/or questions that are specific to the entity (e.g., how the individual perceives the entity). In some examples, the analysis system 140 may tailor the questions in the questionnaire 123 based on various factors associated with the individual that is answering the questions.

For example, the analysis system 140 may revise the questions in the questionnaire 123 based on demographic or location information associated with or otherwise provided by the individual. In another example, the analysis system 140 may revise the questions in the questionnaire 123 based on responses or feedback received from other individuals that were interested in the opportunity and who had previously answered the questions in the questionnaire 123. In another example, the questions in the questionnaire 123 may be revised based on the number of individuals that are interested in the opportunity. In yet another example, the questions in the questionnaire 123 may be revised based on additional information received from the first computing device 105 associated with the entity. In some examples, the questions may be revised based on the detected key words in a given dialogue and whether those key words are associated with a score, category, heat map etc. In an example, as more and more of the detected words are associated with a score, category or heatmap, the analysis system 140 may learn how and when to generate questions that obtain the desired key words in a response of an individual. As a result, the matching system 130 may update the questionnaire 123 in real-time or substantially real-time as additional information is received.

In some examples, the analysis system 140 is trained based on the changes that are made to the questions and/or based on additional information that is received. For example, if the entity associated with the first computing device 105 provides feedback about the qualifications the entity is looking for, that feedback will be incorporated in subsequently generated questions. In some examples, the training may be entity specific. In other examples, the training may be applied across all entities for which the matching system 130 generates questionnaires.

In another example, the analysis system 140 may generate questions based on information it has received from various individuals. For example, and as discussed in more detail below, the analysis system 140 may receive experience 120 information from various individuals. As this information is received, the analysis system 140 may categorize the information and/or generate entity-specific questions based on the experience 120 information. Thus, the questions in the questionnaire may be both entity specific and individual specific to help ensure a match between the individual and the entity.

For example, if the experience 120 information indicates that the individual is involved with various initiatives, the analysis system 140 may generate questions regarding whether the individual would be interested in helping the entity with those initiatives. In another example, if the experience information 120 indicates that the individual has a particular skill set, the analysis system 140 may generate questions regarding whether the individual would be interested in learning a new skill set and/or would the individual be interested in training others to acquire that skill set.

Once the questionnaire 123 is generated and/or revised, the questionnaire 123 may be provided to the first computing device 105 associated with the entity. Additionally, the questionnaire 123 may be provided to a recruiter or other entity that is interviewing potential candidates for the opportunity offered by the entity. In yet another example, the questionnaire 123 may be provided to the second computing device 115 associated with the individual. In some examples, the questions may be generated and provided to a recruiter, an entity and/or an individual in real-time or substantially real-time. For example, during an interview, answers to a question in the questionnaire 123 may be provided to the analysis system 140. In response to receiving the answer, a follow-up question may be generated and provided to the recruiter by the analysis system 140 via a messaging system 145. The follow-up question(s) may be generated based on the detection of key words, categories, etc. such as previously described.

The matching system 130 may also include a storage system 150. The storage system may store the requested qualifications 110. Additionally, the storage system may store the transcription of the requested qualifications 110 from the transcription system 135. The storage system 150 may also store the questionnaire 123 as well as any updates to the questionnaire 123.

As briefly described above, the second computing device 115 may communicate with the matching system 130 via the network 125. In an example, an individual associated with the second computing device 115 may be seeking an employment opportunity. The individual may have various skills and qualifications (shown as experience 120). As such, the individual, via the second computing device 115, may provide the experience 120 to the matching system 130 via the network 125.

Like the requested qualifications 110, the experience 120 may be provided to the matching system 130 in a number of ways. For example, an individual associated with a provider of the matching system 130 may have a natural language conversation with the individual associated with the second computing device 115 and ask for information (e.g., using the questionnaire 123) about the experience 120 of the individual. As this information is received, it may be provided to the transcription system 135 of the matching system 130 in real-time or substantially real-time. In another example, this information may be provided to the transcription system 135 upon completion of the conversation.

In another example, the experience 120 may be included in an electronic message or other form of electronic communication. For example, the individual associated with the second computing device 115 may provide the experience 120 to the transcription system 135 via an email, internet fillable form, word processing document and the like.

Upon receipt of the experience 120, the transcription system 135 may analyze or otherwise process the experience 120. In an example, the processing may include standardizing the experience 120 based on one or more criteria. In another example, the processing may be used to format the experience 120 such that an analysis system 140 of the matching system 130 may be able to understand the experience 120 information. In another example, the transcription may be provided to the analysis system 140. The analysis system 140 may then analyze the experience information 120 with respect to the questionnaire 123 and rank the individual. The ranking may be based on a comparison with other individuals and/or may be based on a match between the experience 120 information and the questions in the questionnaire.

The storage system 150 may store the experience 120 information. Additionally, the storage system 150 may store the transcription of the experience 120 information from the transcription system 135.

Upon receipt of the experience 120 information, the requested qualifications 110 and/or the answers to the questionnaire 123, the analysis system 140 of the matching system 130 may also determine whether there is a match between the requested qualifications 110 and the experience 120 information. In some examples, the requested qualifications 110 and the experience 120 information may be required to meet a matching threshold.

For example, if the requested qualifications 110 includes a request for candidates with experience in a particular programming language for 5+ years, individuals that have 4+ years of experience with the same or a similar programming language may be determined to be a match.

In some examples, the matching threshold may be adjusted based on various factors. These factors may include, an education level associated with the requested qualifications 110, a starting salary associated with the employment opportunity, a title associated with the employment opportunity, an amount of time the entity has been looking to fill the position and so on. Although specific factors have been mentioned, these are for example purposes only and may be applied equally to the experience information 120. Results provided by the analysis system 140 may also be stored in the storage system 150.

In another example, the entity may indicate have one or more client specific desirability characteristics or “must haves” (e.g., the candidate is required to have a computer science degree) and/or one or more “would like to have”. In some examples, the desirability characteristics may be associated with or otherwise arranged in a hierarchy. Each of these desirability characteristics may be associated with one or more key words, categories or scores. Thus, during analysis of conversations between entities/individuals, the system 100 may easily determine if the candidate and/or entities are good fits for each other.

In some examples, one or more “would like to have” desirability characteristics may be associated with a particular “must have” desirability characteristic. Thus, questions may get more granular down a particular desirability characteristic chain of questions.

If a match or potential match is found, the results may be generated and provided to the first computing device 105 and/or the second computing device 115 via a messaging system 145. For example, and as shown in FIG. 1B, the messaging system 145 may provide results 155 to the first computing device 105 associated with the entity and may also provide the results 155 to a second computing device 115 associated with the individual. In some examples, the results 155 that are provided to the first computing device 105 and the second computing device 115 may be the same or similar. In another example, the results 155 may be tailored specifically for the recipient.

As also shown in FIG. 1B, the results 155 may also be provided to a third computing device 160. The third computing device 160 may be associated with an entity or individual that is associated with the or otherwise provides the matching system 130. As such, an individual associated with the third computing device 160 may be able to contact the individual associated with the second computing device 115 and/or the entity 105 to determine or otherwise gauge interest of the respective parties.

In some examples, the results may be displayed and updated in real time or substantially real time in response to received input. For example, if the results 155 included multiple candidates, input may be provided in a user interface that changes one or more criteria. As the criteria changes (e.g., location), the displayed list of candidates may also change.

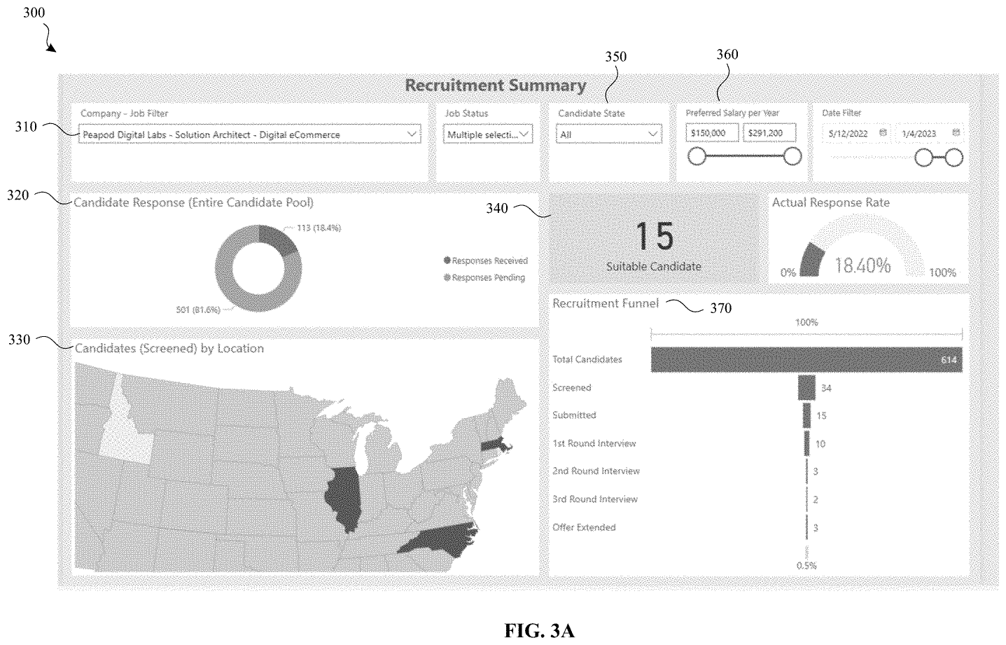

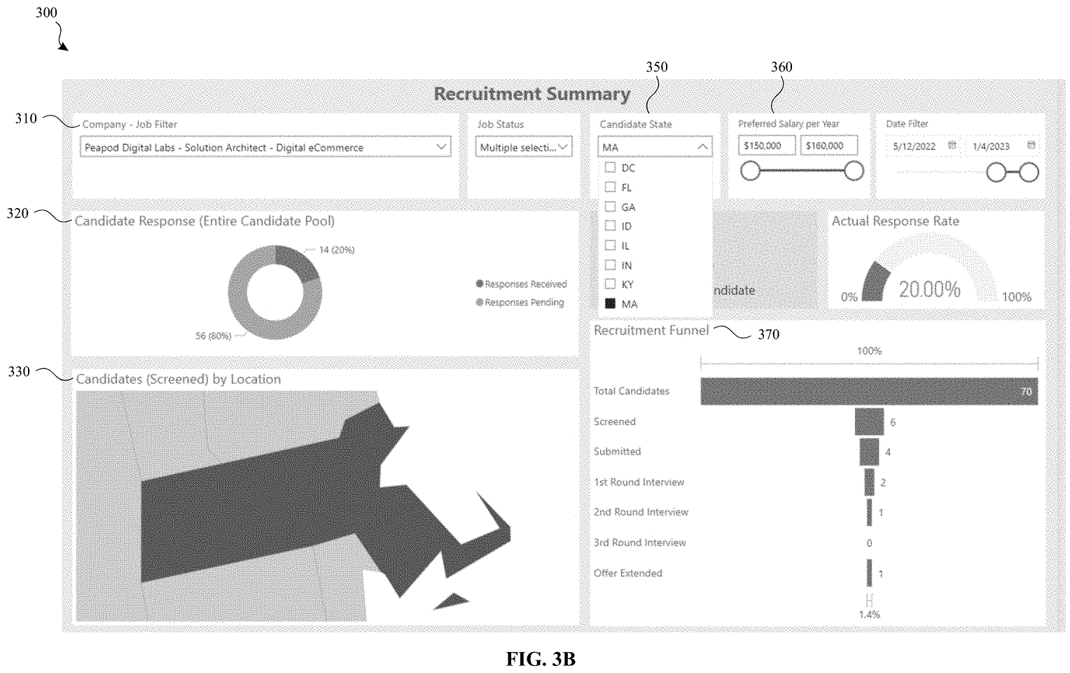

For example, and referring to FIG. 3A, FIG. 3A illustrates an example user interface 300 that shows a list of all available candidates that meet criteria for a particular entity according to an example. In an example, the user interface 300 includes a number of windows of information. In an example, each window includes a selection mechanism that allows one or more filters to be applied. As a particular filter is applied to one or more of the windows, the information provided in the user interface is updated.

For example, the user interface 300 includes a Company—Job Filter 310. The Company—Job Filter 310 enables an individual to select one or more entities that has a hiring need as well as information related to each hiring need. The user interface 300 may also include a Candidate Response 320 window that provides information about an entire candidate pool for the selected opportunity (e.g., the opportunity selected in Company—Job Filter 310).

The user interface may also provide information 330 regarding a location of one or more candidates/individuals. The user interface 300 may also provide a Candidate State filter 350, a Preferred Salary filter 360 and also provide information about the number of suitable candidates 340 based on the currently selected filter(s). The Recruitment Funnel 370 window may provide the overall number of possible candidates for the particular opportunity indicated by the Company—Job Filter 310. In this example, the total number of candidates is 614. This window also shows how many candidates have been screened, how many candidates have been submitted, and the status of one or more interviews. As one or more of the filters are changed, the information displayed in the user interface 300 is updated.

For example and referring to FIG. 3B, FIG. 3B illustrates the user interface 300 of FIG. 3A after a filter has been applied to the information displayed in the user interface 300 according to an example. Specifically, in the example shown in FIG. 3B, an individual has selected the Candidate State filter 350. As a result, all of the information shown in in the user interface has been updated to show information about candidates that live in Massachusetts as well as the number of candidates (e.g., 70) that meet the newly updated criteria. Although the Candidate State filter 350 has been selected, one more multiple other filters may also be selected.

Referring back to FIG. 1, in response to receiving the results 155, additional information 165 may be received by the matching system 130. The additional information 165 may include information about why a candidate was or was not selected by the entity, why the individual did or did not accept the position if a position was offered, additional interests of the individual and/or the entity and so on. In another example, the additional information 165 may include information that is volunteered by the individual associated with the second computing device 115. This may include demographic information, DEI information and so on. In examples, the additional information may be volunteered or otherwise provided by the individual at anytime (e.g., when experience 120 is being obtained or otherwise gathered). In another example, the additional information 165 may be received from a third-party or source.

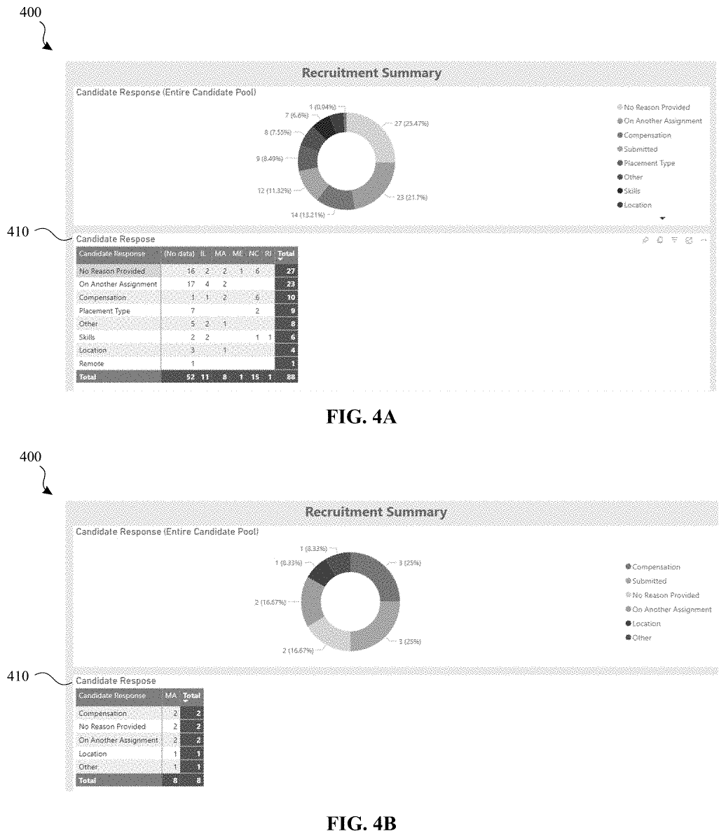

For example, and as shown in FIG. 4A, a user interface 400 may display reasons 410 a particular candidate was interested in a given position. As with other user interfaces described herein, user interface 400 may also be filtered (e.g., by state) and the information may be updated such as shown in FIG. 4B.

In another example, the additional information 165 may include additional experience information associated with the individual, additional qualifications requested by the entity, information about the accuracy of the transcription system 135, the analysis system 140 and/or the messaging system. As such, the additional information 165 may be used to train each of the various systems of the matching system 130 thereby enabling the matching system to learn how to determine more accurate matches between individuals and entities.

As indicated above, the matching system 130 may rank the candidates based on her experience and/or answers to the questions in the questionnaire 123. In another example, the entity may also be ranked. In some examples, the ranking of the entity may be based on information provided by the individual. This information may include whether the entity is involved in initiatives that the individual is involved in, a carbon footprint of the entity, public perception of the entity and the like. Thus, the matching system 130 may help ensure that the individual's values align with the values of the entity and vice versa.

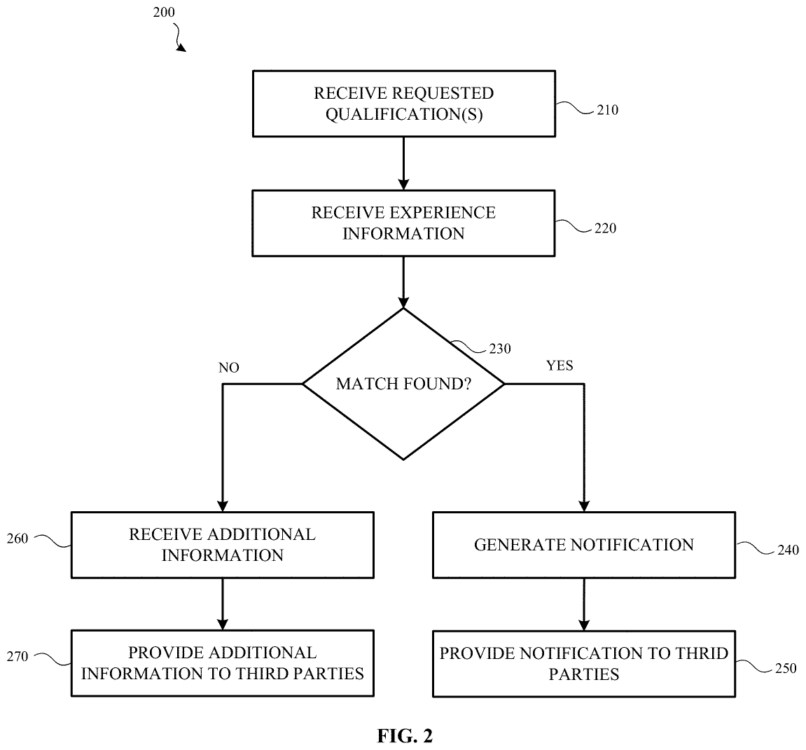

FIG. 2 illustrates a method 200 for matching and individual having a particular skill set with one or more entities according to an example. The method 200 may be performed by one or more systems of the system 100 shown and described above with respect to FIG. 1A and FIG. 1B.

Method 200 begins when information regarding requested qualifications is received (210) by the matching system. In an example, the requested qualifications may include skill and/or experience an entity is looking for with respect to a particular employment opportunity.

The method 200 also includes receiving (220) experience information. The experience information may be received by or otherwise associated with an individual such as described above. Although operations 210 and 220 are shown as being sequential, these operations may occur in parallel or substantially parallel. In another example, the order of the operations may be reversed. In some examples, as this information is received, the information is normalized such as described above.

Upon receipt of the requested qualifications and the experience information, a determination (230) is made as to whether a match is found. The match may be based on the experience information matches the requested qualification information. The match may also be based on any received additional information such as described above.

If a match is not found, the system may receive (260) or request additional information. The additional information may include a request for information about whether a candidate and/or employment opportunity that is not an exact match (or does not meet a matching threshold) would be of interest to the entity and/or the individual. In another example, the additional information may be a request for follow-up information about the experience of the individual and/or clarification about the requested qualifications.

Once the additional information is received and analyzed, the additional information may be provided (270) to the entity and/or the individual.

However, if it is determined in operation 230 that a match is found, the matching system may generate (240) a notification. The notification may include a comparison between the requested qualification and the experience information. The notification may then be provided (250) to the entity and/or the individual.

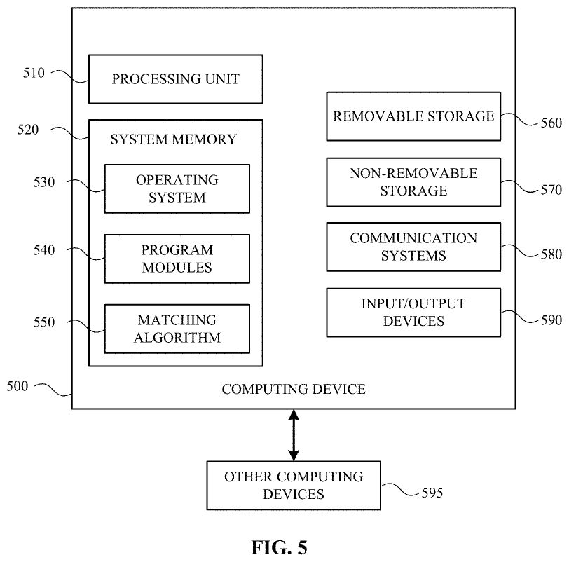

FIG. 5 is a system diagram of a computing device 500 according to an example. The computing device 500, or various components and systems of the computing device 500, may be integrated or associated with an enterprise routing engine, a core routing engine, a signing server, a customer network, an ingress gateway, an egress gateway, a tagging system, or a destination network. As shown in FIG. 5, the physical components (e.g., hardware) of the computing device are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for executing and/or determining a matching algorithm 550. A number of different program modules and data files may be stored in the system memory 520. While executing on the processing unit 510, the program modules 540 may perform the various processes described above.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
receiving one or more qualification requirements associated with an entity;
receiving experience information associated with an individual;
normalizing the qualification requirements based, at least in part, on a first criterion;
normalizing the experience information based, at least in part, on a second criterion;
generating a mapping between the normalized qualification requirements and the normalized experience information;
generating a user interface based, at least in part, on the mapping between the normalized qualification requirements and the normalized experience information; and
providing the user interface to a computing device.

2. The method of claim 1, wherein the one or more qualification requirements are based, at least in part, on a natural language input.

3. The method of claim 1, wherein the experience information is based, at least in part, on a natural language input.

4. The method of claim 1, further comprising receiving additional information about the entity from the individual.

5. The method of claim 1, further comprising updating the user interface based, at least in part, on received input.

6. The method of claim 1, further comprising providing a notification to a computing device associated with the individual.

7. The method of claim 1, further comprising determining, based on received input, one or more desirability characteristics associated with the entity.

8. The method of claim 1, wherein the user interface comprises at least two windows and wherein at least one window includes a selection mechanisms for filtering information provided in each of the two or more windows.

9. A system, comprising:
at least one processor; and
a memory for storing instructions that, when executed by the at least one processor, perform operations, comprising:
receiving one or more qualification requirements associated with an entity;
receiving experience information associated with an individual;
normalizing the qualification requirements based, at least in part, on a first criterion;
normalizing the experience information based, at least in part, on a second criterion;
generating a mapping between the normalized qualification requirements and the normalized experience information;
generating a user interface based, at least in part, on the mapping between the normalized qualification requirements and the normalized experience information; and
providing the user interface to a computing device.

10. The system of claim 9, wherein the one or more qualification requirements are based, at least in part, on a natural language input.

11. The system of claim 9, wherein the experience information is based, at least in part, on a natural language input.

12. The system of claim 9, further comprising instructions for receiving additional information about the entity from the individual.

13. The system of claim 9, further comprising updating the user interface based, at least in part, on received input.

14. The system of claim 9, further comprising instructions for providing a notification to a computing device associated with the individual.

15. The system of claim 9, further comprising instructions for determining, based on received input, one or more desirability characteristics associated with the entity.

16. The system of claim 9, wherein the user interface comprises at least two windows and wherein at least one window includes a selection mechanisms for filtering information provided in each of the two or more windows.

17. A method, comprising:
receiving experience information associated with an individual;
normalizing the experience information based, at least in part, on a criterion;
comparing the normalized experience information to received qualification requirements associated with an entity, the qualification requirements being associated with a hierarchy;
generating a user interface based, at least in part, on the comparing; and
providing the user interface to a computing device.

18. The method of claim 17, wherein the experience information is normalized based, at least in part, on one or more key words.

19. The method of claim 17, further comprising updating the user interface based, at least in part, on received input.

20. The method of claim 17, wherein the user interface has a plurality of windows, wherein in each window of the plurality of windows includes information associated with information in each of the other windows of the plurality of windows.
